(19) United States
(12) Patent Application Publication
(10) Pub. No.: US 2009/0282398 A1
(43) Pub. Date: Nov. 12, 2009

(54) ON-THE-FLY ADDITION OF PRODUCTS TO AN EXISTING INSTALLATION

(75) Inventors: Jennifer Shen, Santa Clara, CA (US); Christoph Huber, Redmond, WA (US); Om Sharma, Woodinville, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/116,967

(22) Filed: May 8, 2008

(51) Int. Cl. G06F 9/445

(52) U.S. Cl. 717/174

(57) ABSTRACT

A user interface to a software installer is arranged to enable users to select additional software products that are downloaded, queued, and then installed dynamically (i.e., “on-the-fly”) on a PC while an existing software installation is performed. The user interface may be configured to provide an indication of the progress of software products that are currently being installed, as well as a list of other software products that are available for installation. When a user selects a new software product from the list, the installer will immediately fetch the software and queue it for installation. The user interface will be updated to display the installation progress for the new software product along with the installation progress for the existing products. The user can repeat the process and continue to add new products that will also be installed on-the-fly until all the desired software products are installed on the user's PC.

### BACKGROUND

The development of the Internet and widespread adoption of broadband access by consumers has opened up the use of new software delivery vehicles where software applications, updates, and patches may be readily and conveniently accessed from online sources. The online software provider will package various software components which are placed on a server for download. A software user may then typically download a standalone installer program or utilize a web browser that supports a service for installing and registering software components that are downloaded from the server, as well as any files required by the components.

Software delivered via the Internet is conventionally installed on a personal computer (“PC”) using a linear process where a user first downloads the software from the provider which is then installed. During the installation, the user typically becomes locked into the process and must wait for the installation to be completed. While some user interfaces provided by the software installer display advertisements or educational messages to make use of the installation time, the user must still wait before being given an opportunity to select additional software products or components for installation on the PC.

Online software delivery generally performs well and meets the expectations of many users. However, some users express frustration with the traditional linear software delivery and installation process and the waiting that it entails.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A user interface to a software installer is arranged to enable users to select additional software products that are downloaded, queued, and then installed dynamically (i.e., “on-the-fly”) on a PC while an existing software installation is performed. In an illustrative example, the user interface is configured to provide an indication of the progress of software products that are currently being installed, as well as a list of other software products that are available for installation.

When a user selects a new software product from the list, the installer will immediately fetch the software from an online service and queue it for installation. The user interface will be updated to display the installation progress for the new software product along with the installation progress for the existing products. The user can repeat the process and continue to add new products that will also be installed on-the-fly until all the desired software products are installed on the user's PC.

Advantageously, the present on-the-fly addition of new products to an existing installation of software provides an efficient way for users to select and install software products that makes use of time that might otherwise be wasted. And for the software provider, the user interface provides up-sell opportunities for additional software products that are constantly presented to the user during the installation process and for which the user may immediately take advantage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment that facilitates practice of the present on-the-fly addition of software to an existing installation in which a user at a client PC interacts with an online service over the Internet;

FIG. 2 shows an illustrative architecture that operates on the client PC shown in FIG. 1;

FIG. 3 shows the components of an illustrative installation user interface;

FIG. 4 shows an illustrative merchandising web page;

FIG. 5 is a flowchart of an illustrative method which may be utilized to provide on-the-fly addition of software to an existing installation;

FIG. 6 shows a first illustrative screen shot of the installation user interface showing completed and pending installations of software products, and additional products that are available for installation on the client PC;

FIG. 7 shows a second illustrative screen shot of the installation user interface in which a user has selected an additional product for installation on the client PC;

FIG. 8 shows a third illustrative screen shot of the installation user interface in which the user clicks a button to begin the installation process for the selected component; and

FIG. 9 shows a fourth illustrative screen shot of the installation user interface in which the selected product has been added to an installation queue.

Like reference numerals indicate like elements in the drawings. Elements are not drawn to scale unless otherwise indicated.

### DETAILED DESCRIPTION

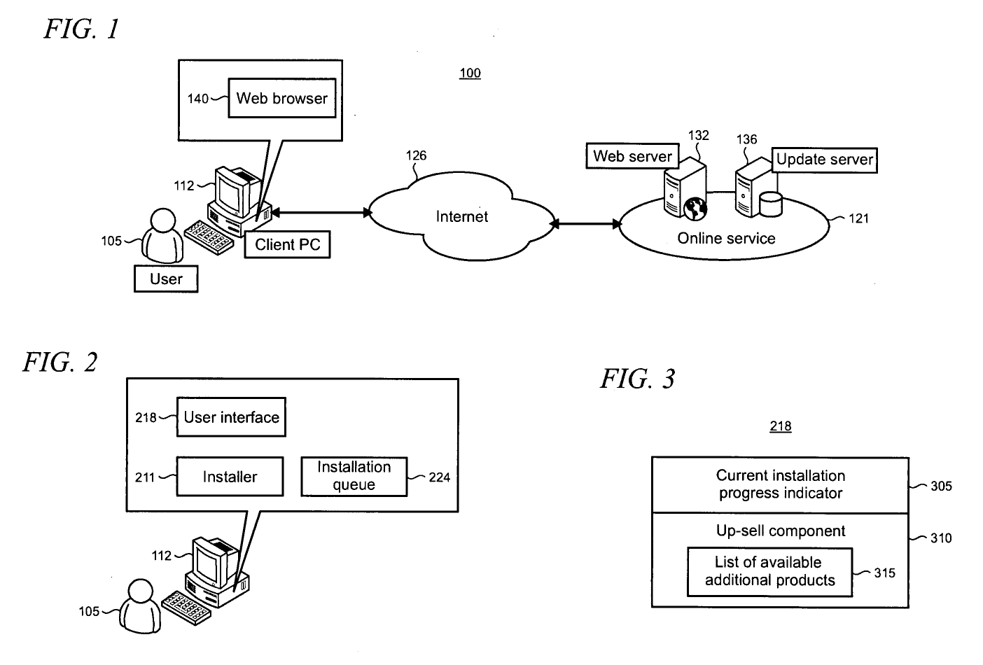

FIG. 1 shows an illustrative computing environment 100 that facilitates practice of the present on-the-fly addition of software in which a user 105 at a client PC 112 interacts with an online service 121 over the Internet 126. The service 121 may use software delivery over the Internet 126 to support a variety of business models including those, for example, that provide software free of charge, on a licensed basis for a fee or by subscription, in association with a software-as-service model, or using a combination of several models. In some cases, use of the delivered software will be subject to the viewing of advertisements by the user 105.

While a client PC 112 is used in this example, it is noted that the present arrangement for on-the-fly addition of software may be adapted to work with other devices as required to meet the needs of a particular implementation. For example, thin client devices that have networking capabilities may also be supported in some cases. Such devices may include smart phones, mobile phones, personal digital assistants (“PDAs”), pocket PCs, handheld game devices, personal media players, ultra-mobile computers, and the like, which typically have reduced resources (such as memory, network bandwidth, screen resolution, and processing power) compared with the client PC 112. Devices with PC-like capabilities such as game consoles and set-top-boxes, for example, may also be utilized. In all cases, the delivered software products will typically be matched to the capabilities of the devices on which they are intended to operate.

The online service 121 includes a web server 132 and an update server 136. The web server 132 is accessible from a web browser 140 on the client PC 112. Typically, the user 105 will use the browser 140 to view web pages called merchandising pages served by the web server 132 to learn about software products offered by the service 121 and then initiate the installation process when the user 105 identifies a desired product.

The update server 136 is arranged in this example to store and serve the software products that are available for download over the Internet 126 and installation on the client PC 112. Other resources may also be utilized by the service 121 (not shown in FIG. 1) such as business systems, directory or access control servers for those implementations that restrict access to the update server to certain users (e.g., in fee-based delivery scenarios), and the like. It is emphasized that the resources utilized in any given online service may vary, and include resources that are different from those shown in FIG. 1 and/or described above. In addition, the service's resources may be logically or physically distributed across one or more data centers.

In this example, when the user 105 visits the merchandising page served by the web server 132 and decides to get a software product, a standalone executable (such as an .ocx, a .dll, or an .exe file) is downloaded over the Internet 126 and then installed and registered on the client PC 112. As shown in FIG. 2, when the downloaded executable is run, a software installer program 211 is installed on the client PC 112 which supports a user interface 218 and an installation queue 224. However, it is noted that the installer 211 only needs to be downloaded and installed as a one-time event. That is, once the installer 211 is installed on the client PC 112, the user 105 can visit merchandising pages over a multiplicity of different web sessions to select and install software programs over time without having to download and install the installer 211 over again.

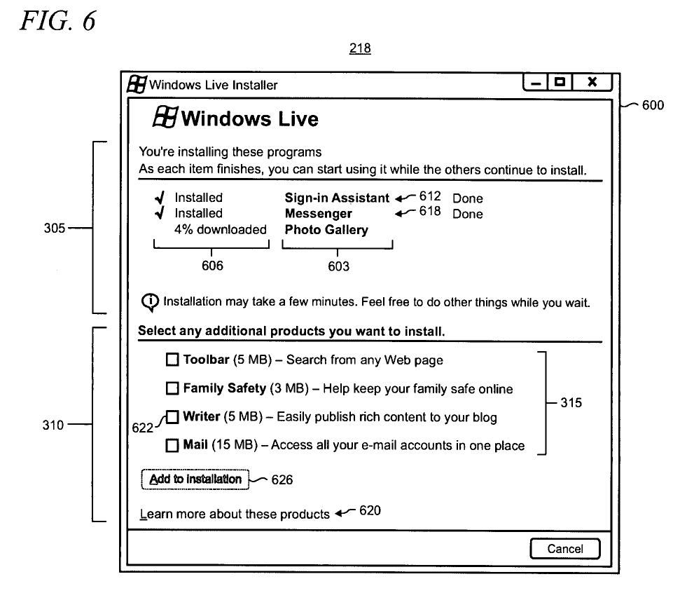

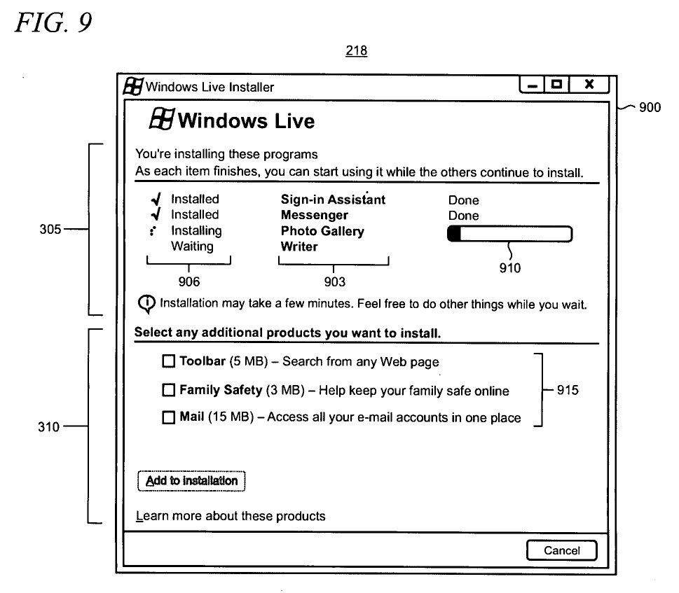

The user interface 218 includes two components, as shown in FIG. 3, which are a current installation progress indicator 305 and an up-sell component 310. The progress indicator is configured to provide an indication to the user 105 of the installation progress of software products that are currently being installed on the client PC 112. The up-sell component 310 provides a list 315 to the user 105 of other software products that are available for download from the service 121 and installation on the client PC 112. Screen shots of specific illustrative examples of the user interface 218 which utilizes these components are shown in FIGS. 6-9.

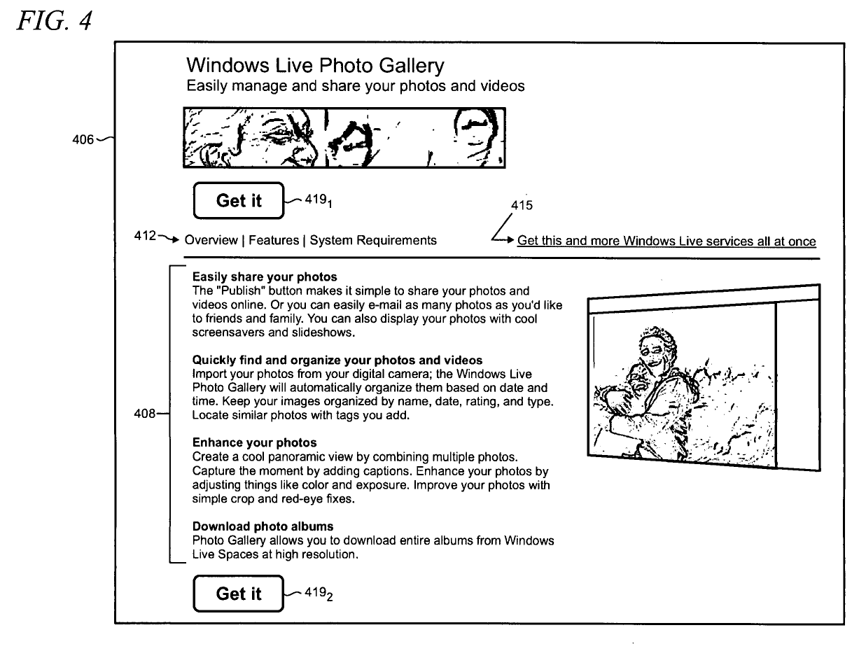

FIG. 4 shows an illustrative merchandising web page 406 that is served by the web server 132 and displayed by the browser 140 on the client PC 112. The merchandising web page 406 in this example describes a software product used with a content sharing service named “Photo Gallery” that is provided under the Windows Live™ brand of online services. The content sharing service enables the user 105 to upload content such as images and videos that can then be managed and shared with other users.

While this example shows and describes software products that are utilized with online services, it is emphasized that standalone products that operate entirely locally may also be supported by the present arrangement. In addition, a mix of locally running applications and those that interact with online services may also be utilized in some cases.

As shown in FIG. 4, the merchandising web page 406 includes a description of the software product and service as indicated by reference numeral 408. Links to other web pages (as collectively indicated by reference numeral 412) are provided to which the user may navigate to learn more details about the Photo Gallery software product. A link 415 to other merchandising web pages is also provided where the user 105 can go to get more information about other software products that are available from the service 121. Two buttons marked “Get it” (indicated by reference numerals 419₁ and 419₂) are included on the merchandising page 406. It is emphasized that the merchandising web page 406 is intended to be illustrative and other configurations for the page may also be utilized as needed. For example, a merchandising web page may be arranged to feature multiple software products at the same time.

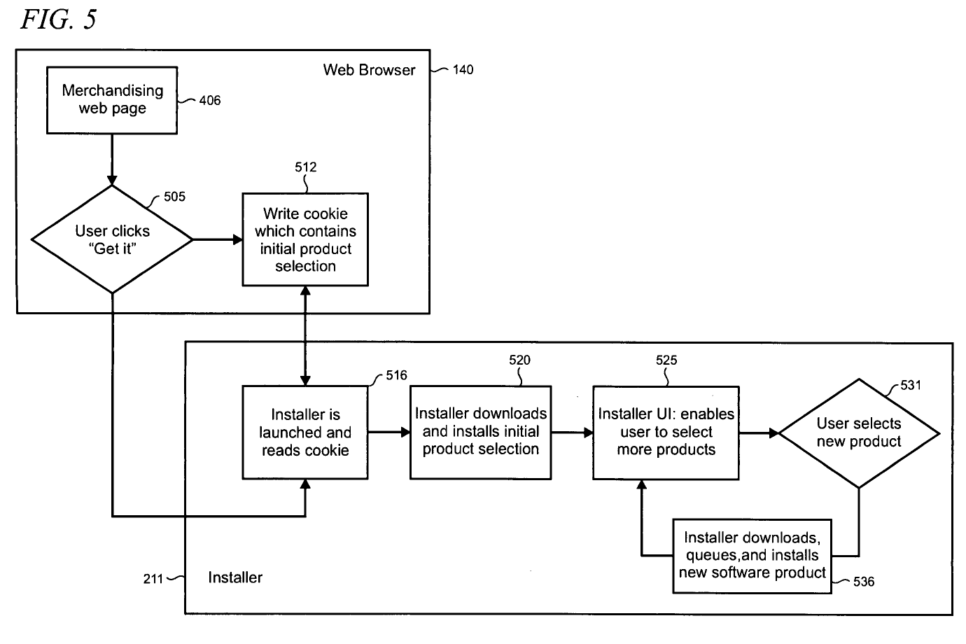

As shown in FIG. 5, when the user 105 clicks one of the “Get it” buttons 419 on the merchandising web page 406 (as indicated by reference numeral 505), a cookie is written (512) via the web browser 140 to the client PC 112 which contains the user's initial product selection. In this example, as noted above, the initial product selection is the Photo Gallery software product shown on the merchandising page 406.

When the user 105 launches the installer 211 (after downloading from the service 121 and installing it on the client PC 112), the installer 211 reads the cookie (516). The installer 211 will then fetch (i.e., download) the initial software product selection from the update server 136 at the service 121 and begin installing it on the client PC 112 (520).

As the installer 211 performs the download and installation of the initial product selection, the installer user interface 218 shows the progress of that installation using the indicator 305 and enables the user 105 to add more software products displayed by the up-sell component 310 to be fetched from the service 121 for installation on the client PC 112 (525).

When the user 105 selects a new product (531), the installer 211 will download the selected product, queue it in the installation queue 224, and then install it from the queue (536). This process of enablement, selection, and installation may be iterated until the user 105 has picked all the desired software products from the list of additional products displayed by the up-sell component 310.

FIGS. 6-9 show illustrative screen shots of the installation user interface 218. As shown in FIG. 6, the user interface 218 is divided into two sections to display the progress indicator 305, and the list 315 supported by the up-sell component 310. It is emphasized that the particular software products shown in FIGS. 6-9 and described in the accompany text are intended to be illustrative and should not be viewed as a limitation on the scope of the present arrangement for on-the-fly addition of software. Any of a variety of different software products may be utilized to meet the needs of a particular implementation. In addition, in some implementations the installable software may include one or more components of a product (but not necessarily complete applications) or may be arranged as a patch or an update, for example, to an existing or downloadable product. Accordingly, the term “software product” as used herein is intended to cover complete applications, components of applications, patches or updates. Trial versions of software may also be supported in some scenarios.

The progress indicator 305 further lists all the software products installed or to be installed by the installer 211, as indicated by reference numeral 603, and the status of each product in the installation process, as indicated by reference numeral 606. Screen 600 shows that the user 105 had previously selected and installed two other software products—“Sign-in Assistant” and “Messenger” as indicated by the respective reference numerals 612 and 618. Sign-in Assistant 612 is a browser add-on that provides sign-in support for multiple user IDs. Messenger 618 supports an instant messaging (“IM”) service that enables the user 105 to connect to other IM users using text, voice, or video.

Screen 600 further shows that the user 105 has selected Photo Gallery which is currently 4% downloaded from the update server 136 as indicated by the progress indicator 305.

The list 315 displayed by the up-sell component 310 shows, in this example, four additional software products from which the user 105 may choose along with a brief description of each. The “Toolbar” product is a browser add-on that provides additional functionalities for browsing the World Wide Web. The “Family Safety” product works with the browser to help the user 105 filter information from the Internet based on family members' ages. The “Writer” product is a desktop application that assists the user 105 in publishing content to the user's blog (web log). The “Mail” product is an e-mail program that provides a unified mail client for multiple e-mail accounts with integrated security protection.

A link 620 is provided which when clicked by the user 105, will direct the web browser 140 to web pages on the web server 132 which can provide more information beyond the brief description included in the user interface 218.

In screen 600, the user 105 has not selected any additional software products from the up-sell component 310 (as indicated by the lack of any checks in the checkboxes as representatively indicated by reference numeral 622). Accordingly, the “Add to Installation” button 626 is “grayed out” in the screen 600 and is not operable by the user 105.

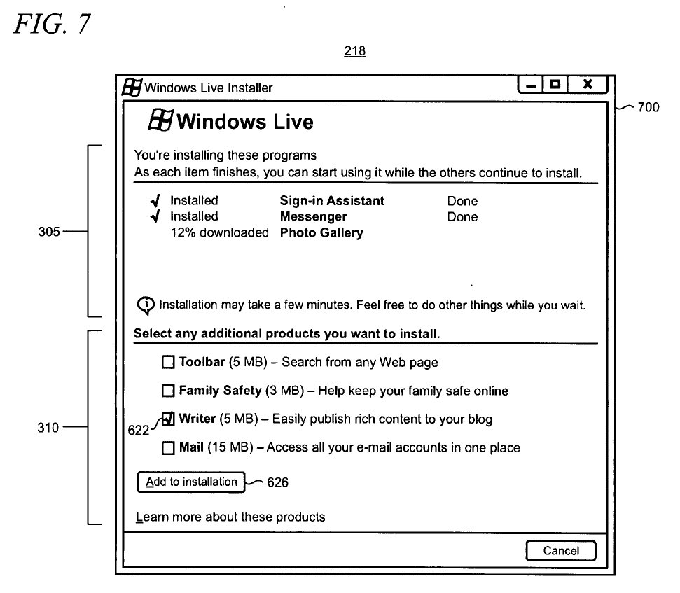

Screen 700 in FIG. 7 shows the user interface 218 at a later point in time where the Photo Gallery product is now 12% downloaded from the update server 136 as indicated by the progress indicator 305. In addition, the user has selected the Writer product as indicated by the check in checkbox 622. At this point, the button 626 becomes operable.

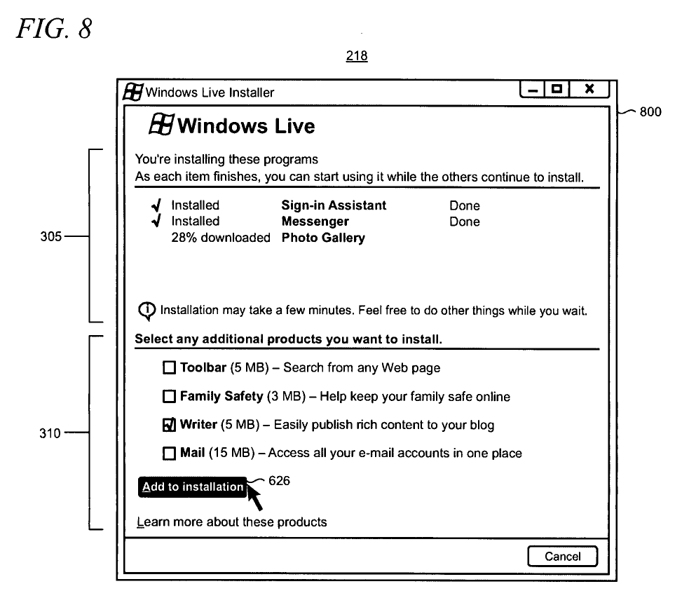

When the user clicks button 626, as shown in the screen shot 800 in FIG. 8, the selected Writer product is then added to the installation queue 224 by the installer 211. By this time, the Photo Gallery product is 28% downloaded.

Screen 900 shows the user interface 218 after the Writer product has been added to the installation queue 224 which is reflected in the list 903 provided by the progress indicator 305. At this point in time, the Photo Gallery product is completely downloaded from the update server 136 and is being installed on the client PC 112 by the installer 211. A meter 910 provides a graphical display of the progress of the installation of Photo Gallery.

As indicated by reference numeral 906, the status of the Photo Gallery product is shown as “Installing.” The Writer application is shown as “Waiting” in the installation queue 224 for its turn to be installed by the installer 211 when the installation of the Photo Gallery product is completed.

While the Photo Gallery and Writer products are going through the installation process, the user 105 is free to select additional products from the list 915 for installation on the client PC 112. Because the Writer product was selected earlier by the user 105 and its installation is pending, it is no longer displayed in the list 915 of available products.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for arranging a user interface for a software installer that is operable on a client device, the method comprising the steps of:
configuring the user interface with a capability for indicating installation status for a software product currently undergoing an installation process by the installer;
configuring the user interface with a capability for listing one or more additional software products that are available for installation on the client device; and
configuring the user interface with a capability for enabling user selection of the one or more additional software products during the installation process by the installer.

2. The method of claim 1 including a further step of configuring the user interface with a capability for indicating installation status of a plurality of software products currently undergoing an installation process by the installer.

3. The method of claim 1 including a further step of configuring the user interface with a capability to link to one or more sources of information describing features, functionalities, or capabilities of the one or more additional software products.

4. The method of claim 1 including a further step of configuring the user interface with a capability for displaying an installed status of one or more previously installed software products.

5. The method of claim 1 in which the installation process comprises downloading a software product from a remote server and installing the software product on the client device.

6. The method of claim 5 in which the remote server is supported by an online service used attendant to a business model selected from one of licensed for free, licensed for fee, subscription basis, software as service, advertising-supported, or a combination thereof.

7. The method of claim 1 in which the client device is selected from one of personal computer, PDA, smart phone, mobile phone, pocket PC, handheld game device, game console, set-top-box, ultra-mobile computer, or personal media player.

8. A method for providing a local software installer used with a remote software delivery service, the method comprising the steps of:
configuring the installer for i) supporting a user interface and an installation queue when running on a local client device, the user interface being configured for presenting to the user, during an installation process of an initially selected software product, an additional software product that is selectable by the user for download and installation on the local client device, ii) fetching the additional software product responsively to input from the user to the user interface and iii) placing the fetched software product into the installation queue for installation upon completion of the installation of the initially selected software product; and
preparing the installer for delivery to the local client device via the remote software delivery service responsively to a request from a user.

9. The method of claim 8 in which the request from the user is implemented using a merchandising web page that is served by the software delivery service.

10. The method of claim 9 in which the merchandising web page is arranged for writing a cookie containing the initially selected software product.

11. The method of claim 10 including a further step of configuring the installer to read the cookie when it is launched on the local client device.

12. The method of claim 11 including a further step of configuring the installer, responsively to reading the cookie, to download and install the initially selected software product.

13. The method of claim 8 in which the user interface is configured for providing links to one or more sources of information describing features, functionalities, or capabilities of the additional software product.

14. The method of claim 8 in which the installation process comprises downloading the initially selected software product from the software delivery service and installing the initially selected software product on the local client device.

15. A method for providing online software delivery to a user at a remote client device, the method comprising the steps of:
serving a merchandising web page to the remote client device, the merchandising web page indicating a software product that is selectable for download by the user and installation on the remote client device;
providing a software installer for installation on the remote client device in response to the user's selection of the software product from the merchandising web page, the installer configured for supporting a user interface and an installation queue when running on the remote client device, the user interface being configured for presenting to the user, during an installation process of the selected software product from the merchandising web page, an additional software product that is selectable for download and installable on the remote client device; and
serving the additional software product to the remote client device responsively to the user's selection.

16. The method of claim 15 including a further step of configuring the user interface with a capability for indicating installation status for a software product undergoing a current installation process by the installer.

17. The method of claim 15 including a further step of configuring the installer for fetching the additional software product and placing the fetched software product into the installation queue.

18. The method of claim 17 including a further step of configuring the installer to install the fetched software product from the installation queue upon completion of the current installation process.

19. The method of claim 15 including a further step of configuring the merchandising page with one or more links to information which describes the selectable software product.

20. The method of claim 15 including a further step of configuring the installer as a standalone executable.
